(19) United States
(12) Patent Application Publication
(10) Pub. No.: US 2005/0201219 A1
(43) Pub. Date: Sep. 15, 2005

(54) Optical head device

(76) Inventors: Tooru Hotsuta, Suwa-gun (JP); Hiroshi Sakai, Suwa-gun (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/035,453

(22) Filed: Jan. 13, 2005

(30) Foreign Application Priority Data
Jan. 23, 2004 (JP) JP 2004-015546

(51) Int. Cl. G11B 7/00

(52) U.S. Cl. 369/44.11

(57) ABSTRACT

An optical head device includes a plurality of laser light sources emitting laser beams with different wavelengths, a common light receiving element for signal detection which is provided with a light receiving surface, and an optical system which guides the laser beams emitted from the plurality of laser light sources to an optical recording medium and guides return light beams from the optical recording medium to the common light receiving element The optical system includes a diffraction type objective lens which is provided with a plurality of concentrically circular areas for respectively focusing the plurality of laser beams at different positions. The light receiving surface of the light receiving element has an inner region and an outer high density flare region. The light receiving element and the optical system are constructed so that a light receiving part of the light receiving element is located in an inner region not the outer high-density flare region which is generated around the return light beam passing through a center side area in the laser beam using only the center side area of the diffraction type objective lens.

### CROSS-REFERENCE TO RELATED APPLICATIONS

This application claims priority to Japanese Application No. 2004-15546 filed Jan. 23, 2004, which is incorporated herein by reference.

### FIELD OF THE INVENTION

The present invention relates to an optical head device in which a diffraction type objective lens is used that converges light beams with different wavelengths at different focal points by diffracting operation.

### BACKGROUND OF THE INVENTION

CDs, which include CD-Rs, or DVDs having transparent protective layers with different thicknesses for protecting their recording surfaces and having different recording densities are known as optical recording media. A laser light source for a CD which emits a laser beam with a wavelength of 785 nm is used to reproduce or record data from or on a CD. A laser light source for a DVD which emits a laser beam with a wavelength of 655 nm is used to reproduce data from a DVD. For example, a conventional optical head device for recording and reproducing data on or from two types of optical recording media is constructed such that laser beams converge on the recording surface of a CD and a DVD by using a common objective lens to attain its miniaturization and compactness.

The thickness of the transparent protective layer of a CD for protecting its recording surface is 1.2 mm and the thickness of the transparent protective layer of a DVD is 0.6 mm. The transparent protective layer is thinner for DVDs than the CDs. DVDs have a recording density that is higher than CDs. Accordingly, a diffraction grating including concentrically circular fine step portions are formed on a lens surface having a predetermined refracting power of the objective lens, and incident light beams are diffracted by the diffraction grating as well as the refraction of the lens surface to form a plurality of focus points at different positions in an optical axis. The diffraction type objective lens is provided with a center side area and an outer peripheral side area which are divided in a concentrically circular manner by a position corresponding to the numerical aperture of the CD. When recording or reproducing data on or from a CD is performed, the laser beam passing through the center side area is utilized, and when recording or reproducing data on or from a DVD is performed, the laser beam passing through the center side area and the outer peripheral side area is used. (See, for example, Japanese Patent No. 2,922,851 and Japanese Patent Laid-Open No. 2000-81566).

The optical head device for performing recording or reproducing data on or from two types of optical recording media includes an optical path separation element, which is disposed at a middle position of a return optical path, to guide the return light beam from a CD or a DVD to a common light receiving element, and a reproduced signal, a tracking error signal and a focusing error signal are generated with the common light receiving element

However, when recording or reproducing data on or from a CD is performed in the optical head device, the laser beam is incident on the peripheral area as well as the center side area of the diffraction type objective lens and, after the light beam incident on the peripheral area is reflected by the CD, it is guided to the light receiving element Accordingly, a flare with high-density occurs in the peripheral part of the light beam passing through the center side area of the diffiaction type objective lens. When the flare with the high-density is received in the light receiving element, a noise occurs in the above-mentioned error signal.

### SUMMARY OF THE INVENTION

In view of the problems described above, it is an object and advantage of the present invention to provide an optical head device which is capable of preventing the generation of noise in the tracking error signal even when recording or reproduction of information on or from plural types of optical recording media are performed by using a diffraction type objective lens and a plurality of laser beams with different wavelengths.

In order to achieve the above object and advantage, according to an embodiment of the present invention, there is provided an optical head device including a plurality of laser light sources emitting laser beams with different wavelengths, a common light receiving element for signal detection which is provided with a light receiving surface, and an optical system which guides the laser beams emitted from the plurality of laser light sources to an optical recording medium and guides return light beams from the optical recording medium to the common light receiving element. The optical system includes at least a diffraction type objective lens which is provided with a plurality of concentrically circular areas for respectively focusing the plurality of laser beams at different positions. The light receiving surface of the light receiving element has an inner region and an outer high density flare region. The light receiving element and the optical system are constructed so that the light receiving part of a light receiving element is located in the inner region not the outer high-density flare region which is generated around the return light beam passing through a center side area for the laser beam using only the center side area of the diffaction type objective lens.

In accordance with an embodiment of the present invention, the optical system includes a th beam generating element for making the laser beam that utilizes only the center side area of the action type objective lens, generate three beams. The light receiving element is provided with a main beam light receiving part for receiving a main beam of the three beams and sub-beam light receiving parts for receiving sub-beams of the thee beams which are disposed at both sides of the main beam light receiving part. The light receiving element and the optical system are constructed so that both the main beam light receiving part and the subbeam light receiving parts are located in the inner region.

In accordance with an embodiment of the present invention, the plurality of laser light sources includes a laser light source for a CD emitting a laser beam L _{CD} with a center wavelength of 785 nm and a laser light source for a DVD emitting a laser beam L_{DVD} with a wavelength of 655 nm. The diffraction type objective lens is provided with an incident side refraction surface formed in an aspheric surface having a positive power on which the laser beams L_{CD} and L_{DVD} are incident and an emitting side refraction face formed in an aspheric surface from which the laser beams are emitted to the optical recording medium. The incident side refraction surface is divided into two areas, one of which is a circular center side refraction face area including an optical axis in a concentrically circular manner around the optical axis and, the other of which is an outer side refraction face area surrounding an outer periphery of the center side refraction face area in a ring-shaped manner. A center side diffraction grating is formed on the center side refraction face area which includes a plurality of concentrically circular fine step differences in a saw tooth shape and an outer peripheral side diffraction grating is formed on the outer side refraction face area which includes a plurality of concentrically circular fine step differences in a saw tooth shape. A boundary position between the center side refraction face area and the outer side refraction face area is set to be a position corresponding to a numerical aperture NA=0.45-0.55 for the laser beam L_{CD} for the CD.

In accordance with an embodiment of the present invention, the laser beam L_{CD} for the CD is incident on the outer side refraction face area but diffiacted so as not to converge at a beam spot formation position on a recording face of the CD by the diffiaction action due to the outer peripheral side diffraction grating formed in the outer side refraction face area. However, the return light beam of the outer peripheral side diffraction grating is guided to the light receiving element by the optical system and generates high-density flare around the light beam passing through the center side refraction face area on the light receiving surface of the light receiving element. According to the embodiment of the present invention, the light receiving element and the optical system are constructed so that the light receiving part of the light receiving element is located in the inner region Therefore, the flare is not detected with the light receiving element

In accordance with the present invention, the light receiving element and the optical system is constructed such that the light receiving part of the light receiving element is located in the inner region not the outer high-density flare region which is generated by the return light beam of the laser beam. Therefore, in the case only the center side area of the diffraction type objective lens is utilized, even when the high density flare is generated around the peripheral part of the light beam passing through the center side area, the flare is not detected with the light receiving element Consequently, when recording and reproduction of information on and from plural types of optical recording media are performed by using the diffraction type objective lens and plural types of laser beams with different wavelengths, the tracking error signal or the like can be generated with a high degree of precision even though the aperture diaphragm is not changed whenever the type of optical recording medium for performing recording and reproduction is changed.

Other features and advantages of the invention will be apparent fiom the following detailed description, taken in conjunction with the accompanying drawings that illustrate, by way of example, various features of embodiments of the invention.

### BRIEF DESCRIPTION OF THE DRAWINGS

FIG. 1(A) is a side view showing a layout of the optical system of an optical head device to which the present invention is applied and FIG. 1(B) is its plan view.

FIG. 2 is an explanatory side view showing the converging states of laser beams with different wavelengths by an objective lens in the optical head device to which the present invention is applied.

FIG. 3 is an explanatory view showing a positional relationship between the light receiving surface having an inner region for light receiving parts of the light receiving element and an outer high-density flare region in the optical head device to which the present invention is applied.

### DETAILED DESCRIPTION OF THE PREFERRED EMBODIMENTS

An optical head device to which the present invention is applied will be described below with reference to the accompanying drawings.

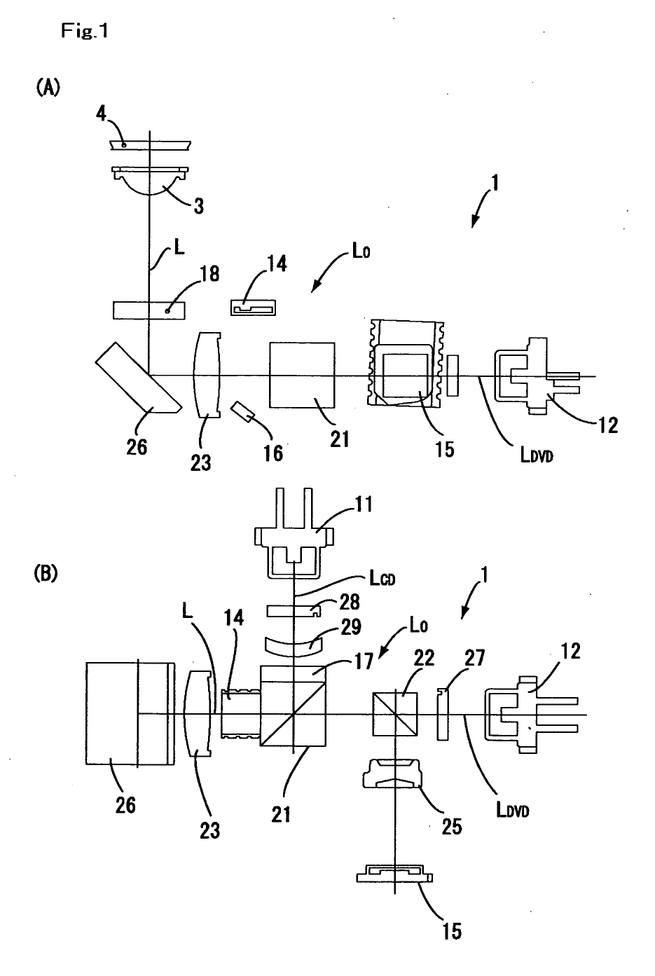

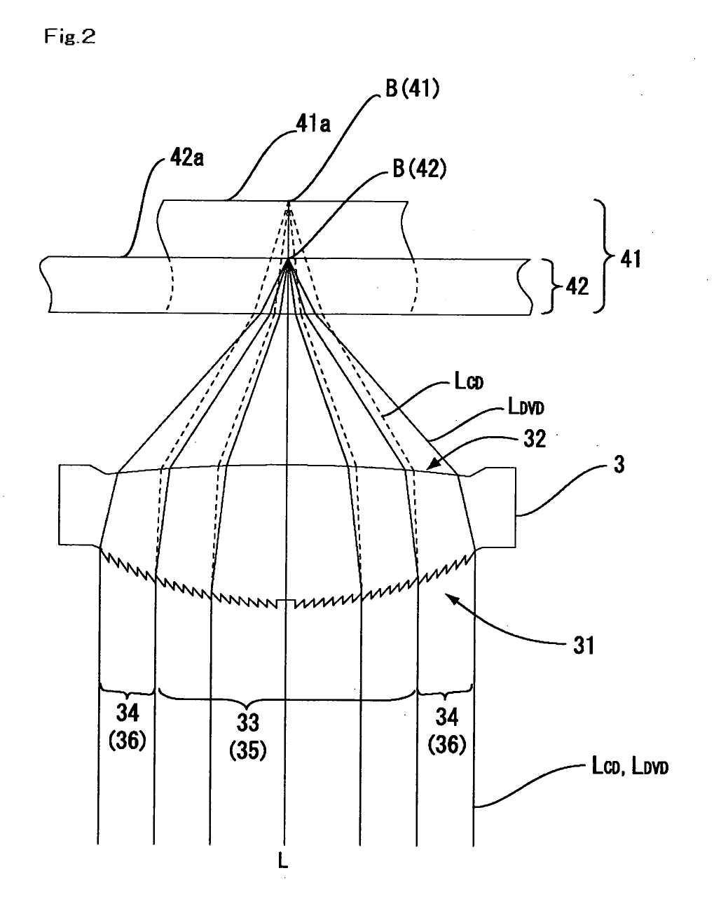

FIG. 1(A) is a side view showing the layout of the optical system of an optical head device to which the present invention is applied and FIG. 1(B) is its plan view. FIG. 2 is an explanatory side view showing the converging states of laser beams with different wavelengths by an objective lens in the optical head device to which the present invention is applied.

In FIGS. 1(A) and 1(B), the optical head device 1 in accordance with an embodiment of the present invention performs reproducing or recording information from or on two types of optical recording media 4 having different thicknesses of substrate and different recording densities such as a CD and a DVD. Therefore, the optical head device 1 is provided with a laser light source 11 emitting a laser light beam LCD for a CD with the center wavelength of 785 nm used for recording or reproducing information on or from the CD and a laser light source 12 emitting a laser light beam L_{DVD} for a DVD with the wavelength of 655 nm used for the DVD. The respective laser beams are guided to the optical recording media 4 through the optical system Lo and the return light beams of the respective laser light beams reflected by the respective optical recording media 4 are guided to a common light receiving element 15.

The optical system Lo includes a first beam splitter 21 which makes the laser beam L_{DVD} go straight through and makes the laser beam L_{CD} reflect to align both the light beams to the system optical axis “L” (optical axis of the objective lens), a collimating lens 23 which makes the laser beams L_{CD}, L_{DVD} emitted from the first beam splitter 21 to be parallel, and a raising mirror 26 for guiding the laser beams L_{CD}, L_{DVD} emitted from the collimating lens 23 to an objective lens 3. The optical system Lo also includes a second beam splitter 22 for guiding the return light beam from the optical recording media 4 to the light receiving element 15 between the second laser light source 12 and the first beam splitter 21.

The optical system Lo includes a grating 28 (three beam generating element) for generating three beams from the laser beam L_{CD} emitted from the first laser light source 11, a relay lens 29, and a ½ wavelength plate 17 between the first laser light source 11 and the first beam splitter 21. A grating 27 for generating three beams from the laser beam L_{DVD} emitted from the second laser light source 12 is provided between the second laser light source 12 and the second beam splitter 22. Further, the optical system Lo includes a sensor lens 25, which is a cylindrical lens, for generating astigmatism to detect a focusing error signal between the light receiving element 15 and the second beam splitter 22. Furthernore, the optical system Lo is provided with a ¼ wavelength plate 18 between the raising mirror 26 and the objective lens 3.

In the optical head device 1 in accordance with the embodiment of the present invention, the peripheral lights of the laser beams L_{CD}, L_{DVD} emitted as a divergence light beam from the first beam splitter 21 are reflected by a mirror 16 to be guided to a light receiving element 14 for front monitor.

As shown in FIGS. 1(A), 1(B) and 2, in the optical head device 1 in accordance with the embodiment of the present invention, the beam spot B(41) of the laser beam L_{CD} is formed by the objective lens 3 on the recording face 41a of the CD 41 as a first optical recording medium. Also, the beam spot B(42) of the laser beam L_{DVD} is formed by the objective lens 3 on the recording face 42a of the DVD 42 as a second optical recording medium.

As described above, the laser beams L_{CD} and L_{DVD} for a CD and a DVD converged on optical recording media 4 (CD 41, DVD 42) are respectively reflected by the optical recording media 4 and then reversely advance the optical system Lo as return light beams to be reflected by the second beam splitter 22 and converge on the common light receiving element 15. For example, information of the optical recording media 4 (CD 41, DVD 42) is reproduced by using a signal which is detected with the common light receiving element 15. Tracking correction and focusing correction are performed by using a tracking error signal and a focusing error signal which are generated with the common light receiving element 15.

As shown in FIG. 2, in the embodiment of the present invention, a convex lens is used as the objective lens 3, which includes an incident side refraction surface 31 formed in an aspheric surface having a positive power on which the laser beams L_{CD}, L_{DVD} are incident, and an emitting side refraction face 32 formed in an aspheric surface from which the laser light beams are emitted to the optical recording media 4.

The incident side refraction surface 31 are divided into two regions, which comprise a circular center side refraction face area 33 (center side area) which is formed in a concentrically circular shape so as to include the optical axis “L” as the center, and an outer side refraction face area 34 (outer peripheral side area) which surrounds the outer periphery of the center side refiaction face area 33 in a ring-shaped manner. The boundary portion between the center side refraction face area 33 and the outer side refraction face area 34 is at the position corresponding to the numerical apertre NA of the CD 41 (laser beam L_{CD} for CD), that is, NA=0.45-0.55.

The area of the entire center side refraction face area 33 is formed with a center side diffraction grating 35 having a plurality of concentrically circular step differences in a fine saw tooth shape. Also, the area of the entire outer side refraction face area 34 is formed with an outer peripheral side diffraction grating 36 having a plurality of concentrically circular step differences in a fine saw tooth shape. Therefore, the objective lens 3 is constructed as a lens having a diffracting function.

The center side diffraction grating 35 formed in the center side refraction face area 33 has the diffraction characteristic such that the beam spot B(41) of the diffracted light of the laser beam L_{CD} passing through the center side refraction face area 33 is formed on the recording face 41a of the CD 41 as shown by the dotted line in FIG. 2. In addition, the center side diffraction grating 35 formed in the center side refraction face area 33 has the diffraction characteristic such that the beam spot B(42) of the diffracted light of the laser beam L_{DVD} passing through the center side refraction face area 33 is formed on the recording face 42a of the DVD 42 as shown by the solid line in FIG. 2.

Also, the outer peripheral side diffraction grating 36 formed in the outer side refraction face area 34 has the diffraction characteristic such that the beam spot B(42) of the diffracted light of the laser beam L_{DVD} passing through the outer side refraction face area 34 is formed on the recording face 42a of the DVD 42.

The light beam component of the laser beam L_{CD} which passes the outer side refraction face area 34 is the unnecessary light component which does not contribute to recording or reproduction. Therefore, in the embodiment of the present invention, the light beam component of the laser beam L_{CD} which passes the outer side refraction face area 34 is diffiacted so as not to converge at the beam spot forming position on the recording face 41a of the CD 41 by diffracting action due to the outer peripheral side diffraction grating 36 formed in the outer side refraction face area 34.

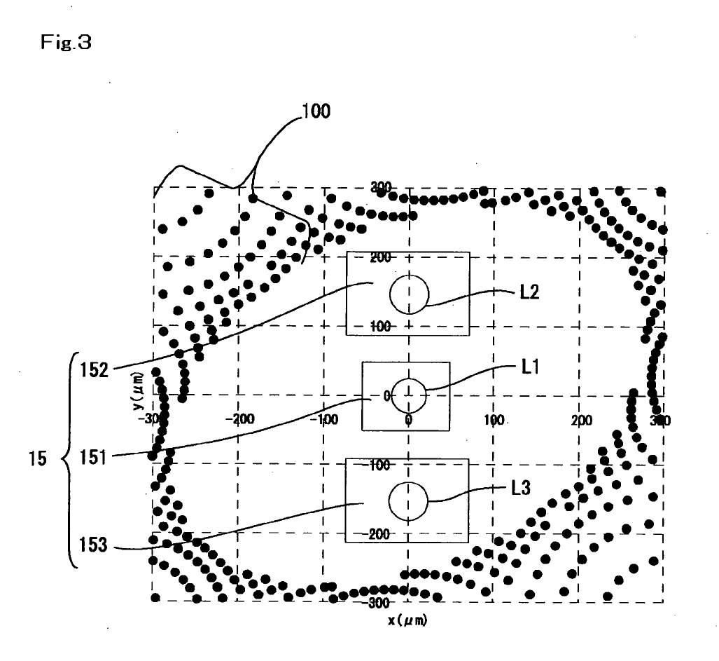

FIG. 3 is an explanatory view showing a positional relationship between the light receiving surface having an inner region for light receiving parts of the light receiving element and an outer high-density flare region in the optical head device to which the present invention is applied.

In the embodiment of the present invention, the light beam component of the laser beam L_{CD} which passes the outer side refraction face area 34 is the unnecessary light component which does not contribute to recording or reproduction. Therefore, the light beam component of the laser beam L_{CD} which passes the outer side refraction face area 34 is diffracted so as not to converge at the beam spot forming position on the recording face 41a of the CD 41. However, the return light beam of the light beam component is guided to the light receiving element 15 by the optical system Lo. Accordingly, the return light beam of the above-mentioned light beam component of the laser beam LCD causes a high-density flare on the light receiving surface of the light receiving element 15 around the light beams which pass through the center side refraction face area 33 (center side diffraction grating 35) as shown in FIG. 3.

In order to prevent the affection of the flare in the embodiment of the present invention, the light receiving element 15 and the optical system Lo are constructed such that both a main beam light receiving part 151 and sub-beam light receiving parts 152, 153 are located within an inner region, not the outer high-density flare region 100, which is generated in the return light beam of the above-mentioned light beam component of the laser beam L_{CD}. The main beam light receiving part 151 receives the main beam L1 of the laser beam that is divided into three beams. The sub-beam light receiving parts 152, 153, which are positioned on both sides of the main beam light receiving part 151, respectively receive sub-beams L2, L3 of the three beams.

In other words, the light receiving element 15 in the embodiment of the present invention is constructed as follows:
the size of the main beam light receiving part 151:
   length—100 μm,; width—100 μm
the size of the sub-beam light receiving parts 152, 153:
   length—15 μm; width—145 μm
the pitch between the main beam light receiving part 151 and the sub-beam light receiving parts 152, 153:150 μm.

In the embodiment of the present invention, the optical system Lo is constructed as follows:
Magnifying power ofthe sensor lens 25: 2.38 times
Magnifying power of the return path of the laserbeam L_{CD}:14.17 times
Magnifying power of the return path of the laser beam L_{DVD}:14.31 times
Specification of the objective lens 3;
   Focal length for the laser beam L_{CD}:3.07 mm
   Numerical aperture NA for the laser beam L_{CD}:0.53
   Focal length for the laser beam L_{DVD}:3.05 mm
   Numerical aperture NA for the laser beam L_{DVD}:0.65

As described above, in the embodiment of the present invention, different focal positions are formed for two laser beams L_{CD}, L_{DVD} with different wavelengths by the objective lens 3 that also utilizes diffraction. Therefore, even when the laser beams L_{CD}, L_{DVD} are converged on optical recording media having different thicknesses of their transparent protective layers, the difference of the thicknesses of the transparent protective layers is not required to be compensated by the positional shift of the objective lens 3 in the focus direction (optical axis direction of the objective lens). Accordingly, the movable range of the objective lens 3 in the focusing direction is not required to be added in the operating distance for a normal focus control to the length of lens shift due to the difference of the thicknesses of the transparent protective layers of the optical recording media. Therefore, the thickness of the optical head device can be reduced and thus the optical head device is suitable to be mounted on a notebook-sized personal computer or the like, which is strongly required to reduce its thickness.

In the embodiment of the present invention, the light receiving element 15 and the optical system Lo are constructed such that the light receiving parts 151, 152, 153 are located within the inner region not the outer high-density flare region 100 which is generated in the return light beam of the above-mentioned light beam component of the laser beam L_{CD}. For example, in the conventional light receiving element 15, the pitch between the main beam light receiving part 151 and the sub-beam light receiving parts 152, 153 is set to be 200 μm. However, in the embodiment of the present invention, the pitch is narrowed to 150 μm. Accordingly, when the high-density flare region 100 is generated around the peripheral part of the light beam which passes through the center side refraction face area 33 of the diffraction type objective lens 3, the flare is not detected with the light receiving element 15. Consequently, when recording and reproduction of information on and from two types of optical recording media (CD, DVD) are performed by using the diffraction type objective lens 3 and two types of laser beams L_{CD}, L_{DVD} with different wavelengths, the tracking ernor signal can be generated with a high degree of precision even though the apeture diaphragm is not changed whenever the type of optical recording medium for performing recording and reproduction is changed.

In the embodiment of the present invention, the present invention is applied to an optical head device for performing recording and reproduction of information on and from two types of optical recording media (CD, DVD) by using two types of laser beams L_{CD}, L_{DVD} with different wavelengths. However, the present invention may be applied to an optical head device for performing recording and reproduction of information on and from three types of optical recording media having different substrate thicknesses and different recording densities. In this case, for example, in addition to the laser beam L_{CD} with the center wavelength of 785 nm which is used in recording and reproduction for the CD 41 and the laser beam L_{DVD} with the wavelength of 655 nm which is used in reproduction or the like for the DVD 42, a laser beam L_{BRD} with the center wavelength of 405 nm is used, which is used for reproducing information from a BRD (Blue-ray Disc) or the like. According to the optical head device 1 constructed as described above, even when the high density flare is generated around the peripheral part of the light beam passing through the center side area, the flare is not detected with the detecting element. Therefore, the tracking error signal can be generated with a high degree of precision even though the aperture diaphragm is not changed whenever the type of optical recording medium is changed.

As described above, according to the present invention, the light receiving element and the optical system is constructed such that the light receiving part of the light receiving element is located in the inner region not the outer high-density flare region which is generated by the return light beam of the laser beam. Therefore, in the case only the center side area of the diffraction type objective lens is utilized, even when the high density flare is generated around the peripheral part of the light beam passing through the center side region, the flare is not detected. Consequently, when recording and reproduction of information on and from plural types of optical recording media are performed by using the diffraction type objective lens and plural types of laser beams with different wavelengths, the tracking error signal can be generated with a high degree of precision even though the aperture diaphragm is not changed whenever the type of optical recording medium for performing recording and reproduction is changed.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device comprising:
a plurality of laser light sources emitting laser beams with different wavelengths;
a common light receiving element for signal detection which is provided with a light receiving surface; and
an optical system which guides the laser beams emitted from the plurality of laser light sources to an optical recording medium and guides return light beams firom the optical recording medium to the common light receiving element;
wherein the optical system includes a diffiaction type objective lens which is provided with a plurality of concentrically circular areas for respectively focusing the plurality of laser beams at different positions; and
the light receiving surface of the light receiving element has an inner region and an outer high density region where the light receiving element and the optical system are constructed so that a light receiving part of the light receiving element is located in the inner region not the outer high-density flare region which is generated around the return light beam passing through a center side area in the laser beam using only the center side area of the diffraction type objective lens.

2. The optical head device according to claim 1, further comprising:
a three-beam generating element which is included in the optical system for maling the laser beam utilizing only the center side area of the diffraction type objective lens generate three beams,
a main beam light receiving part as the light receiving part for receiving a main beam of the three bearns, and
sub-beam light receiving parts as the light receiving part for receiving sub-beams of the three beams which are disposed at both sides of the main beam light receiving part,
wherein the light receiving element and the optical system are constructed so that both the main beam light receiving part and the sub-beam light receiving parts are located in the inner region.

3. The optical head device according to claim 2, wherein
the plurality of laser light sources includes a laser light source for a CD emitting a laser beam L_{CD} with a center wavelength of 785 nm and a laser light source for a DVD emitting a laser beam L_{DVD} with a wavelength of 655 nm,
the diffraction type objective lens is provided with an incident side refraction surface formed in an aspheric surface having a positive power on which the laser beams L_{CD} and L_{DVD} are incident and an emitting side refraction face formed in an aspheric surface from which the laser beams are emitted to the optical recording medium,
the incident side refiaction surface is divided into two areas, one of which is a circular center side refraction face area including an optical axis in a concentrically circular manner around the optical axis and, the other of which is an outer side refraction face area surrounding an outer periphery of the center side refraction face area in a ring-shaped manner,
a center side diffraction grating is forned in the center side refraction face area which includes a plurality of concentrically circular fine step differences in a saw tooth shape and an outer peripheral side diffraction grating is formed in the outer side refraction face area which includes a plurality of concentrically circular fine step differences in a saw-tooth shape, and
a boundary portion between the center side refraction face area and the outer side refraction face area is set to be a position corresponding to a numerical aperture NA=0.45-0.55 for the laser beam L_{CD} for the CD.

4. The optical head device according to claim 3, wherein the laser beam L_{CD} for the CD is incident on the outer side refraction face area and diffracted so as not to converge at a beam spot formation position on a recording face of the CD by the diffraction action due to the outer peripheral side diffraction grating formed in the outer side refraction face area.

5. An optical head device comprising:
a plurality of laser light sources emitting laser beams with different wavelengths;
a common light receiving element for signal detection which is provided with a light receiving surface; and
an optical system which guides the laser beams emitted from the plurality of laser light sources to an optical recording medium and guides return light beams from the optical recording medium to the common light receiving element;
wherein the optical system includes a diffraction type objective lens; and
the light receiving surface of the light receiving element has an inner region and an outer high density region where the light receiving element and the optical system are constructed so that a light receiving part of the light receiving element is located in the inner region not the outer high-density flare region which is generated around the return light beam passing through a center side area in the laser beam using only the center side area of the diffraction type objective lens.

6. The optical head device according to claim 5, wherein the diffiaction type objective lens has a plurality of concentrically circular areas for respectively focusing the plurality of laser beams at different positions

7. The optical head device according to claim 6, further comprising:
a three-beam generating element which is included in the optical system for making the laser beam utilizing only the center side area of the diffraction type objective lens generate three beams, a main beam light receiving part as the light receiving part for receiving a main beam of the three beams, and
sub-beam light receiving parts as the light receiving part for receiving sub-beams of the three beams which are disposed at both sides of the main beam light receiving part,
wherein the light receiving element and the optical system are constructed so that both the main beam light receiving part and the sub-beam light receiving parts are located in the inner region.

8. The optical head device according to claim 7, wherein the plurality of laser light sources includes a laser light source for a CD emitting a laser beam L_{CD} with a center wavelength of 785 nm and a laser light source for a DVD emitting a laser beam L_{DVD} with a wavelength of 655 nm,
the diffraction type objective lens is provided with an incident side refraction surface formed in an aspheric surface having a positive power on which the laser beams L_{CD} and L_{DVD} are incident and an emitting side refraction face formed in an aspheric surface from which the laser beams are emitted to the optical recording medium,
the incident side refraction surface is divided into two areas, one of which is a circular center side refraction face area including an optical axis in a concentrically circular manner around the optical axis and, the other of which is an outer side refraction face area surrounding an outer periphery of the center side refraction face area m a ring-shaped manner,
a center side diffraction grating is formed in the center side refraction face area which includes a plurality of concentrically circular fine step differences in a saw tooth shape and an outer peripheral side diffraction grating is formed in the outer side refraction-face area which includes a plurality of concentrically circular fine step differences in a saw-tooth shape, and
a boundary portion between the center side refraction face area and the outer side refraction face area is set to be a position corresponding to a numerical aperture NA=0.45-0.55 for the laser beam L_{CD} for the CD.

9. The optical head device according to claim 8, wherein the laser beam L_{CD} for the CD is incident on the outer side refraction face area and diffracted so as not to converge at a beam spot formation position on a recording face of the CD by the diffraction action due to the outer peripheral side diffraction grating formed in the outer side refraction face area.
